(19) United States
(12) Patent Application Publication
(10) Pub. No.: US 2007/0091487 A1
(43) Pub. Date: Apr. 26, 2007

(54) Portable foot reflector

(76) Inventors: Frances Lee DeFazio, North Plainfield, NJ (US); Hezvo Mpunga, Linden, NJ (US)

Correspondence Address: FRANCES DeFAZIO, 101 HARRISON AVE., NORTH PLAINFIELD, NJ, 07060, US

(21) Appl. No.: 11/253,677

(22) Filed: Oct. 20, 2005

(51) Int. Cl. G02B 5/10

(52) U.S. Cl. 359/859; 359/871

(57) ABSTRACT

The Portable Foot Reflector is a unique combination of three normally reflective mirrors, two magnification mirrors, and a leg support. The items are all attached to a structure, which allows the user to comfortably self-examine the entire area of the foot. This includes the toes and the area between them. The simplicity of the design, the portability of the device, the low cost of manufacture, the ease of maintenance and use make it a device that could be readily available to anyone with a circulatory problem. The fact that four of the mirrors can be adjusted so that no part of the foot is missed during self-examination is unique to both the Portable Foot Reflector and to the Foot Reflector . . . for Your Health.

### BACKGROUND OF THE INVENTION

### Technical Field

The purpose of this invention is to help older people and those who were infirm, obese, or have diabetes to be able to self-examine their entire foot.

This invention will help in the early detection of infection or foreign objects located anywhere on the foot.

Many diabetics have problems with circulation in their feet, and they therefore cannot feel an infection or foreign object in their feet.

Many people do not have someone to examine their feet.

Many people do not want others looking at their feet.

Many older or diabetic people have weak vision and need the help of magnification, while self-examining their own feet.

### BRIEF SUMMARY INVENTION

Presently there is not readily available any simply to operate reflective device for the entire foot self-examination process.

This device has been recommended by more than ten health care professionals and has been field tested on over fifty individuals with 100% success.

This is a simple and low cost reflective device, which allows all users to self-examine their entire foot area for infections and foreign objects.

This device can be folded into a closed position when not in use for ease of storage and transportation.

### BRIEF DESCRIPTION OF SEVERAL VIEWS OF THE DRAWING

FIG. 1 is a perspective view of the frame.

FIG. 2 is a blown up view of a rivet-connected hinge at the top of the frame.

FIG. 3 is a perspective view of the base of the frame, in a fully opened position.

FIG. 4 is a perspective view of the frame with the hinges slightly closed.

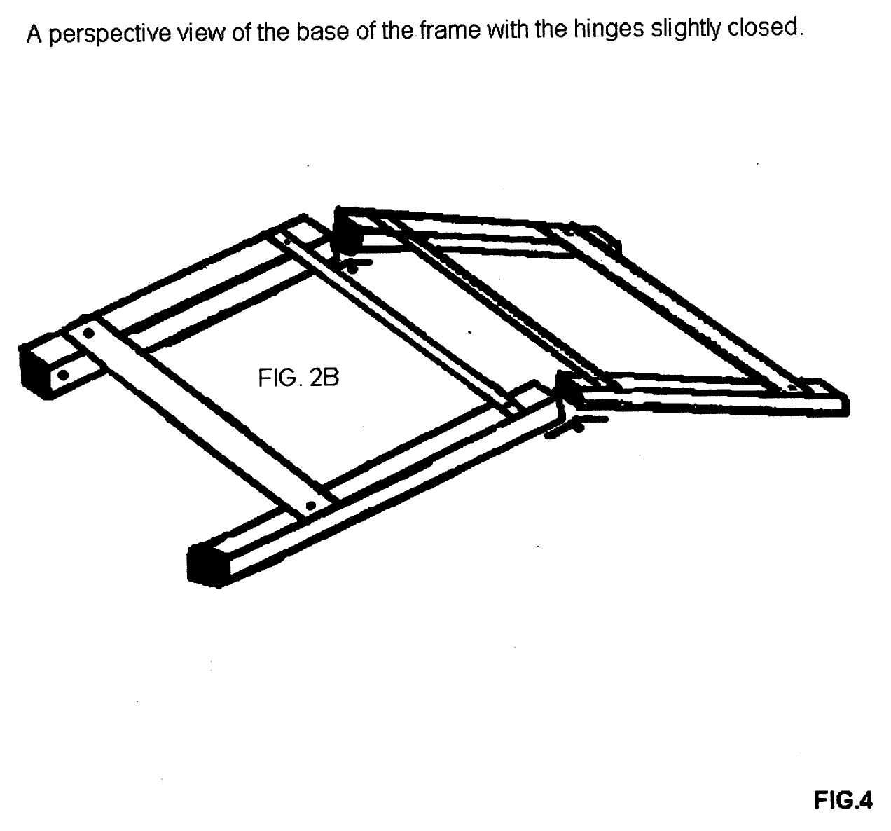

FIG. 5 is a blown up view of the rivet connecting the aluminum plate to the base.

FIG. 6 is a blown up view of the hinge that holds the base together allowing it to open and close.

FIG. 7 is a perspective view of the frame connected to the base.

FIG. 8 is a blown up view of one of the bolts and nuts that connects the frame to the base.

FIG. 9 is a perspective view of the assembled frame from the back with the support beam in place.

FIG. 10 is a blown up view of a rivet connecting the support beam to the frame.

FIG. 11 is a perspective view of the frame from the back with mirror mounts added.

FIG. 12 is a blown up view of the mirror mount brace connected to the frame by rivets.

FIG. 13 is a perspective view from the front with the leg support added.

FIG. 14 is a blown up view of the leg support.

FIG. 15 is a blown up view of the hinge system, which automatically folds the leg support when the device is in the closed position.

FIG. 16 is a perspective view from the front with the mirrors added. Mirrors 2 and 3 can be rotated to different angles for viewing.

FIG. 17 is a perspective view from the front with mirrors 2 and 3 turned around to show magnification mirrors 4 and 5.

FIG. 18 is a side view of the portable foot reflector in its closed position.

FIG. 19 is a side view of the portable foot reflector with the broken lines showing different angles along the rotational axis and the rubber feet.

FIG. 20 is a perspective view of the entire unit in the open position with the attached folding springs.

### DETAILED DESCRIPTION OF THE PERFERED EMBODIMENTS

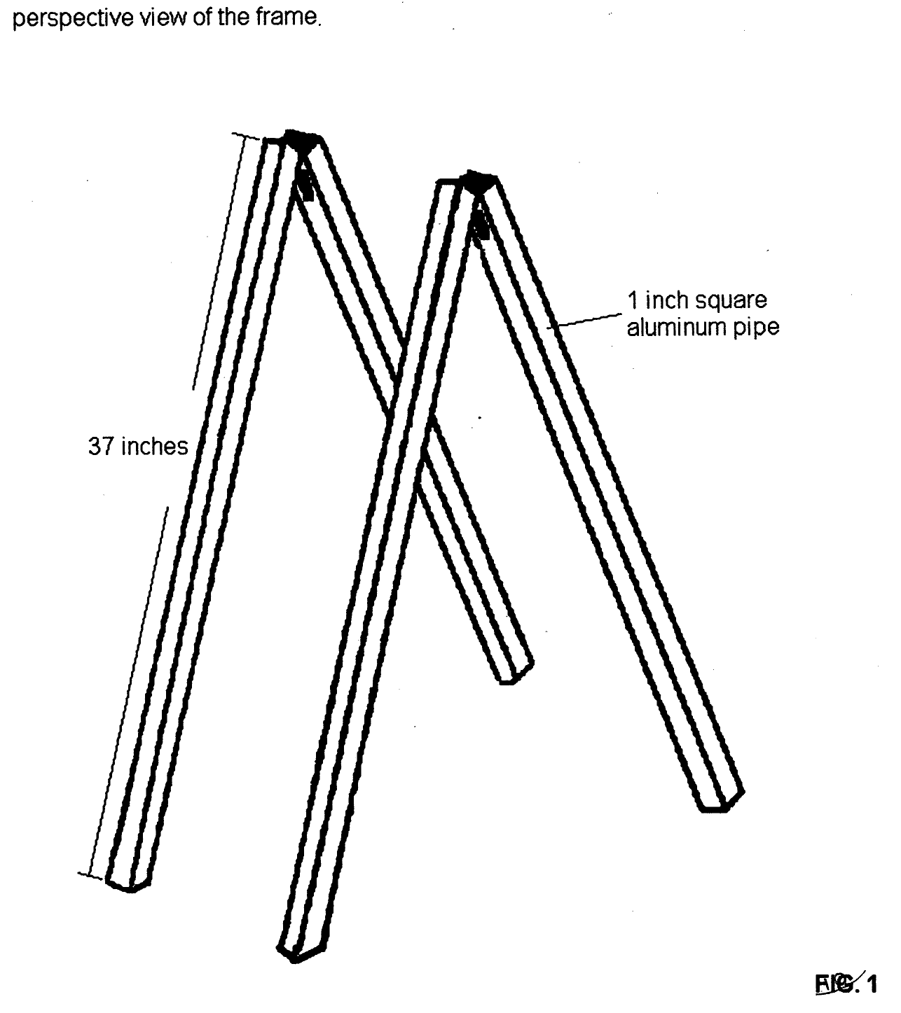

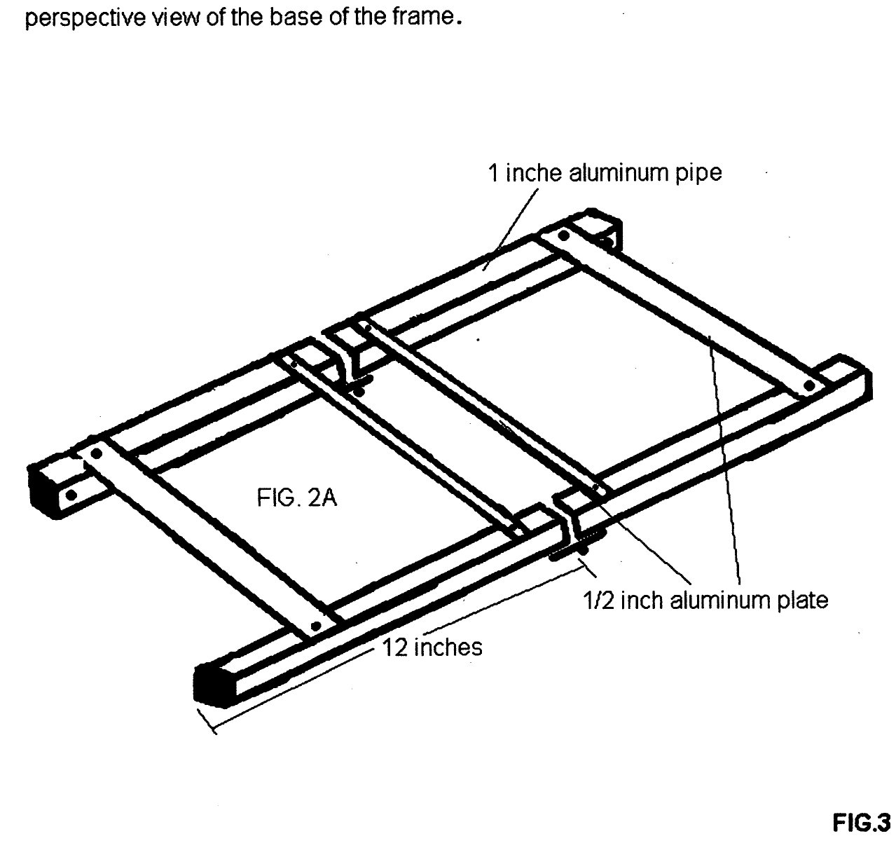

FIGS. 1,2,3, and 4 are perspective views of partially assembled components of the device's frame. Note that there are two hinge connectors in FIG. 1 that allow the device to close and open for ease of storage and mobility, as well as two hinge connectors in the base of the frame illustrated in FIG. 3. They serve the same purpose as in FIG. 1. The frame is made of square aluminum tubing, which measures 1 inch on each side. The hinges and all fastening devices are made of commercial grade quality metal.

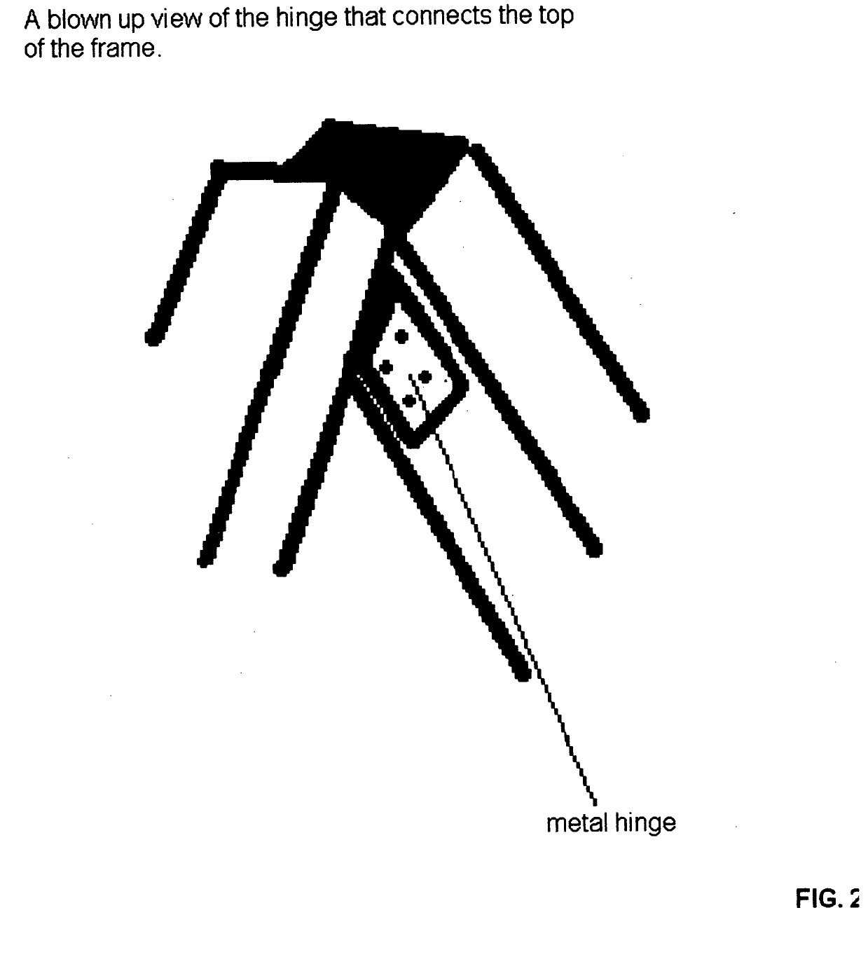

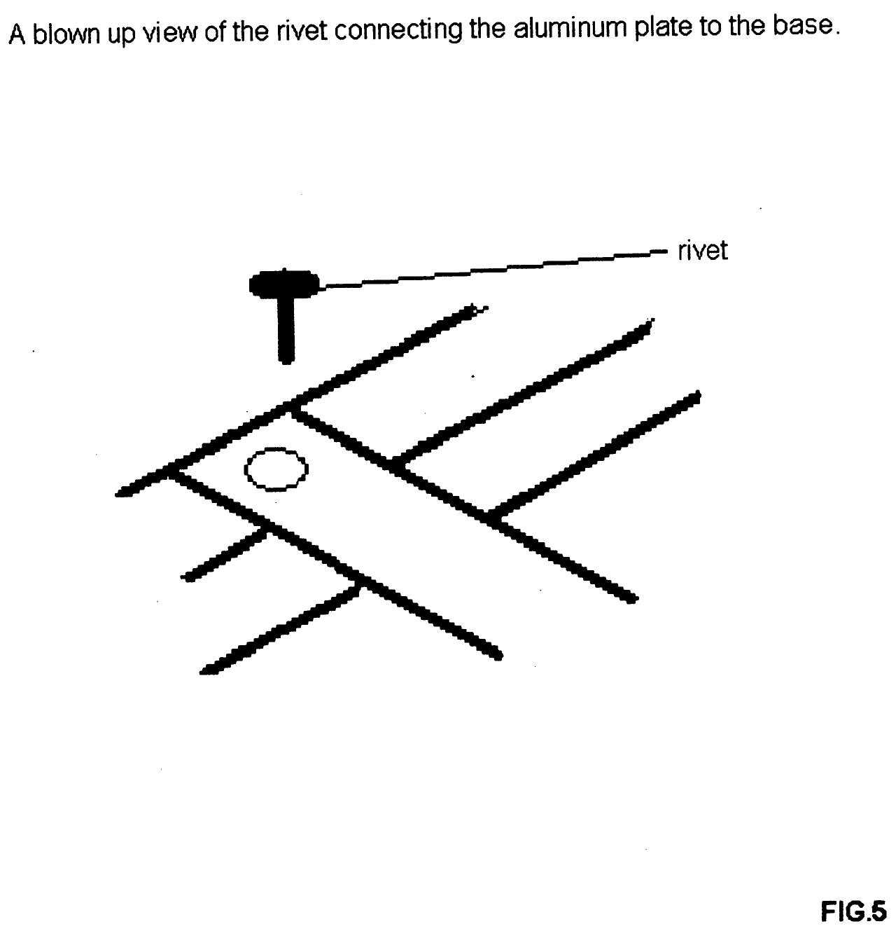

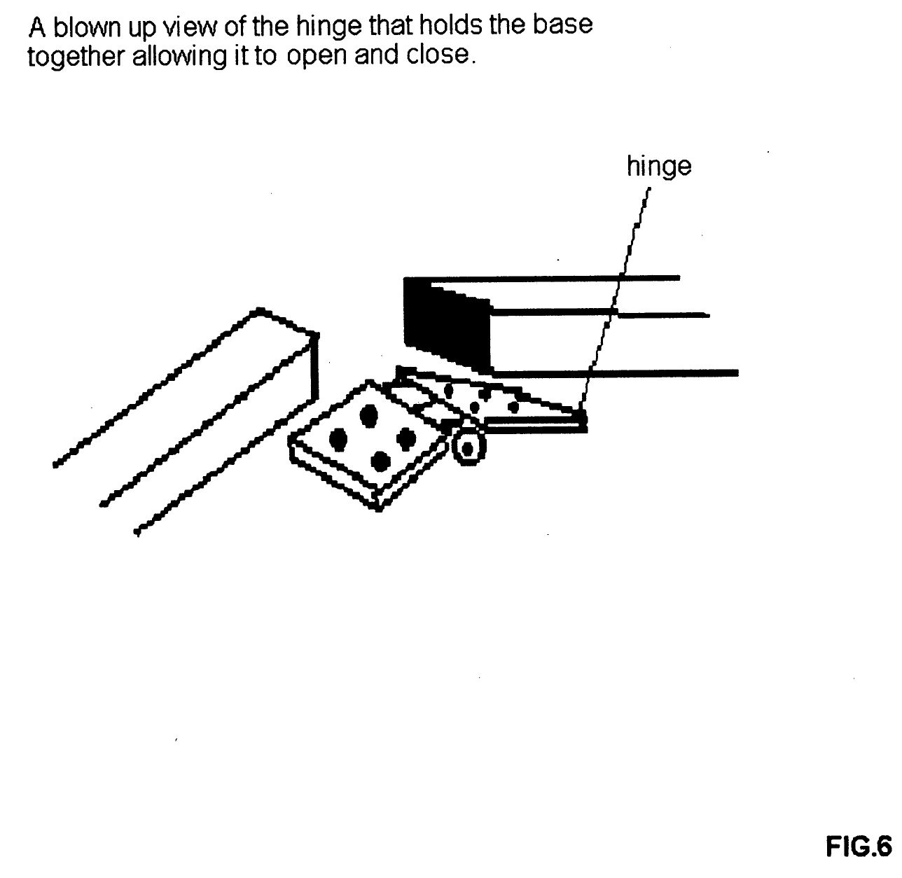

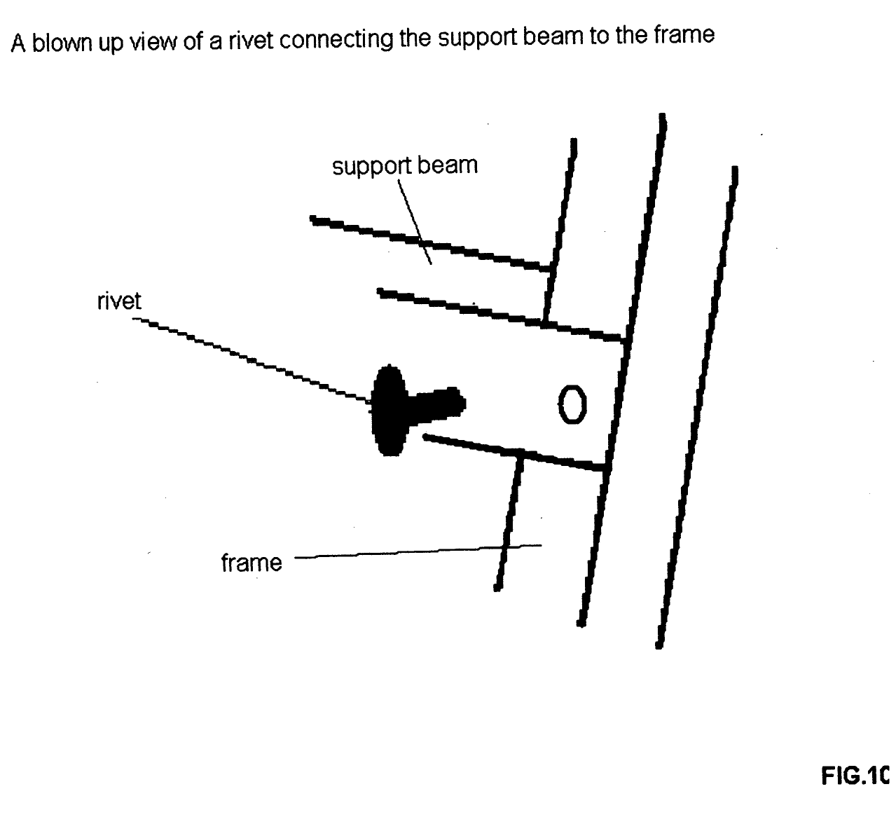

FIGS. 2 and 6 is an enlargement of the attaching hinges and how they can be either riveted or screwed in place. FIGS. 5 and 10 are illustrations of rivets helping to hold the frame together. Looking at FIGS. 2,3,4, and 6 one can understand how the hinges allow the device to open and close.

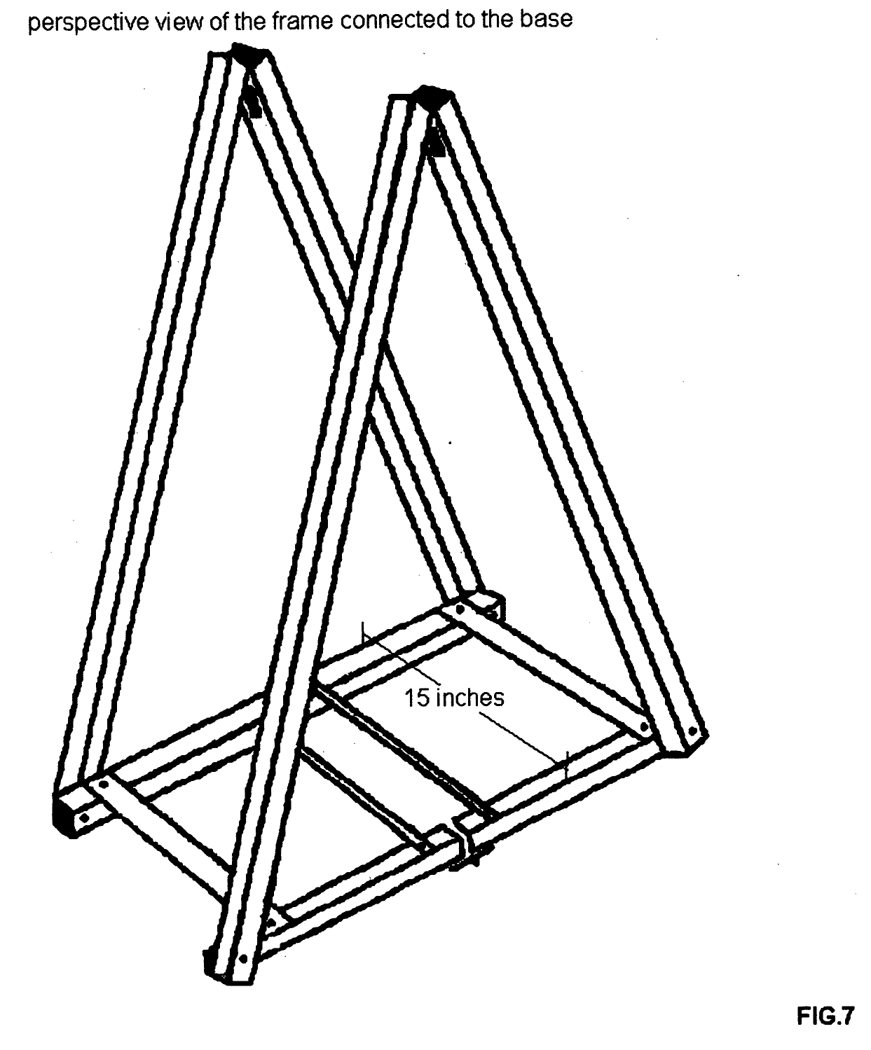

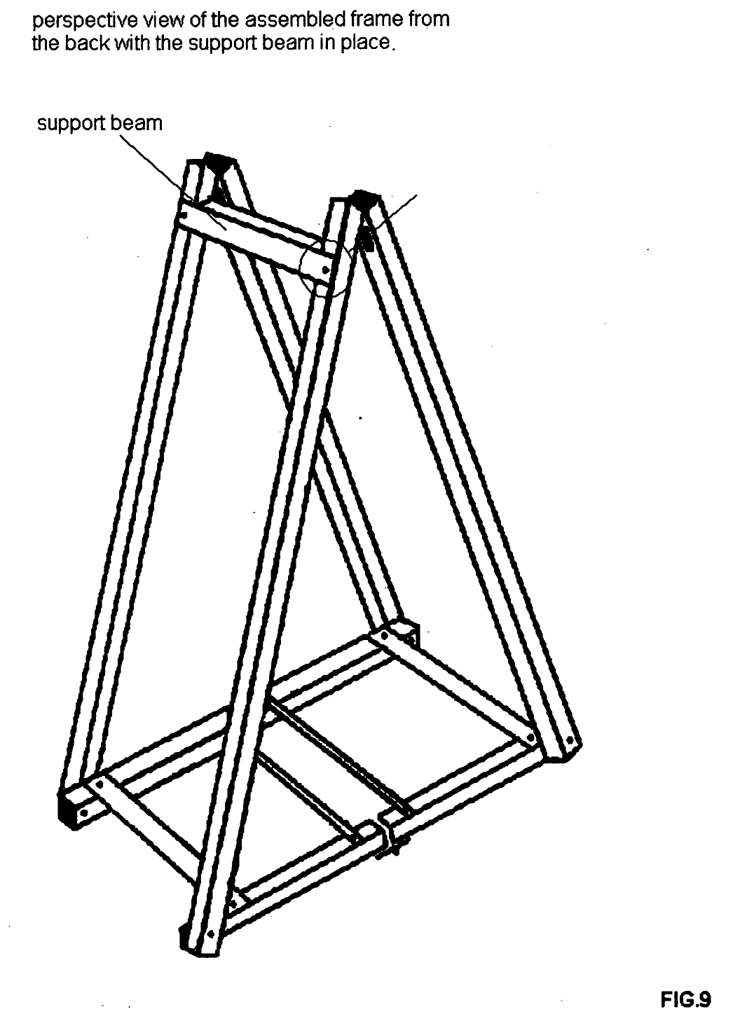

FIGS. 7 and 9 contains the invention's frame plus attached aluminum support beams. FIG. 9 contains all components of the framing structure. The framing materials and fasteners are the same as in FIGS. 2,3, and 5. The overall height of the device is 36 inches. The width is 20 inches and the length of the base is 26 inches.

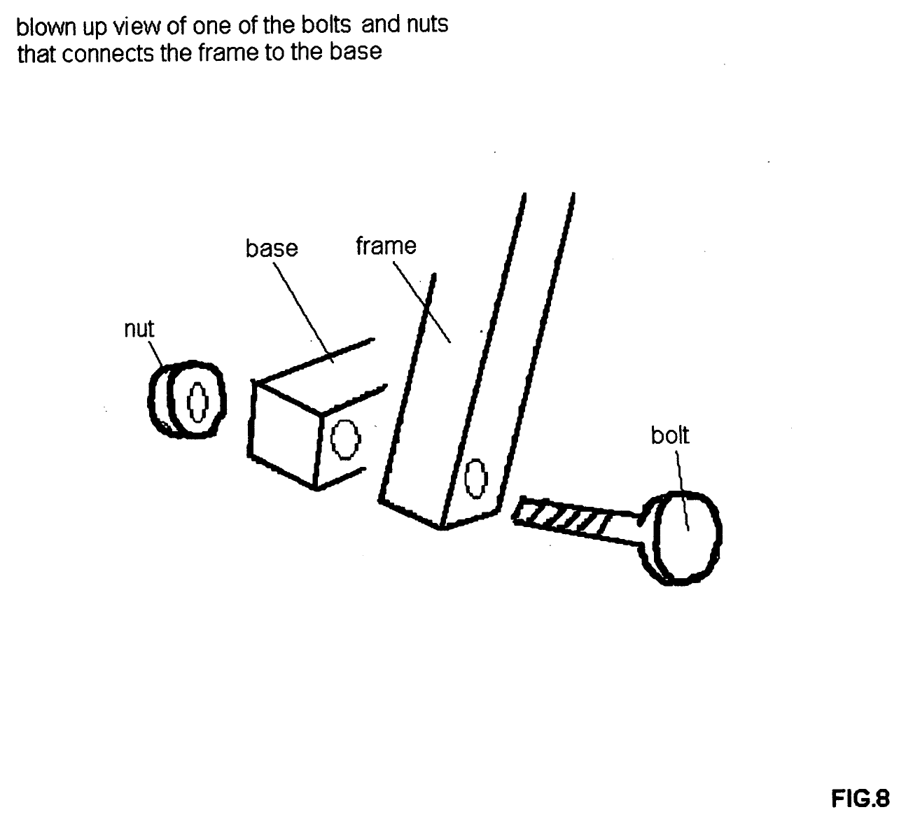

FIG. 8 illustrates how the upper frame is attached to the base frame.

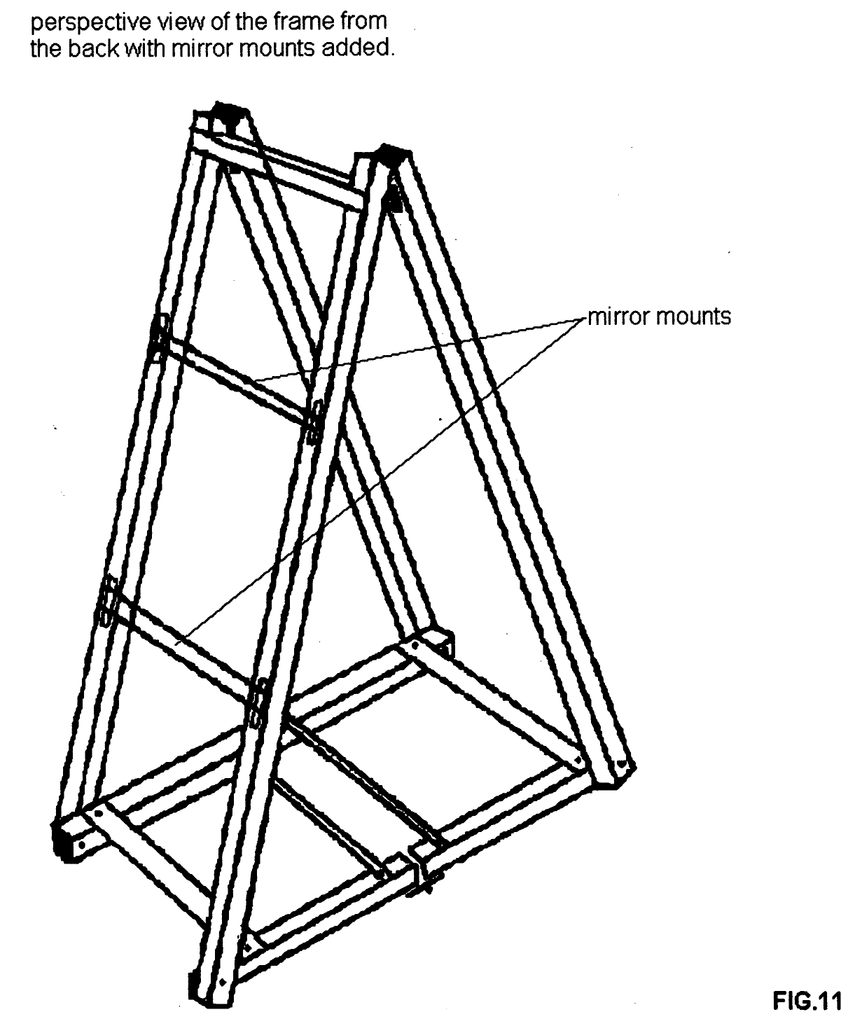

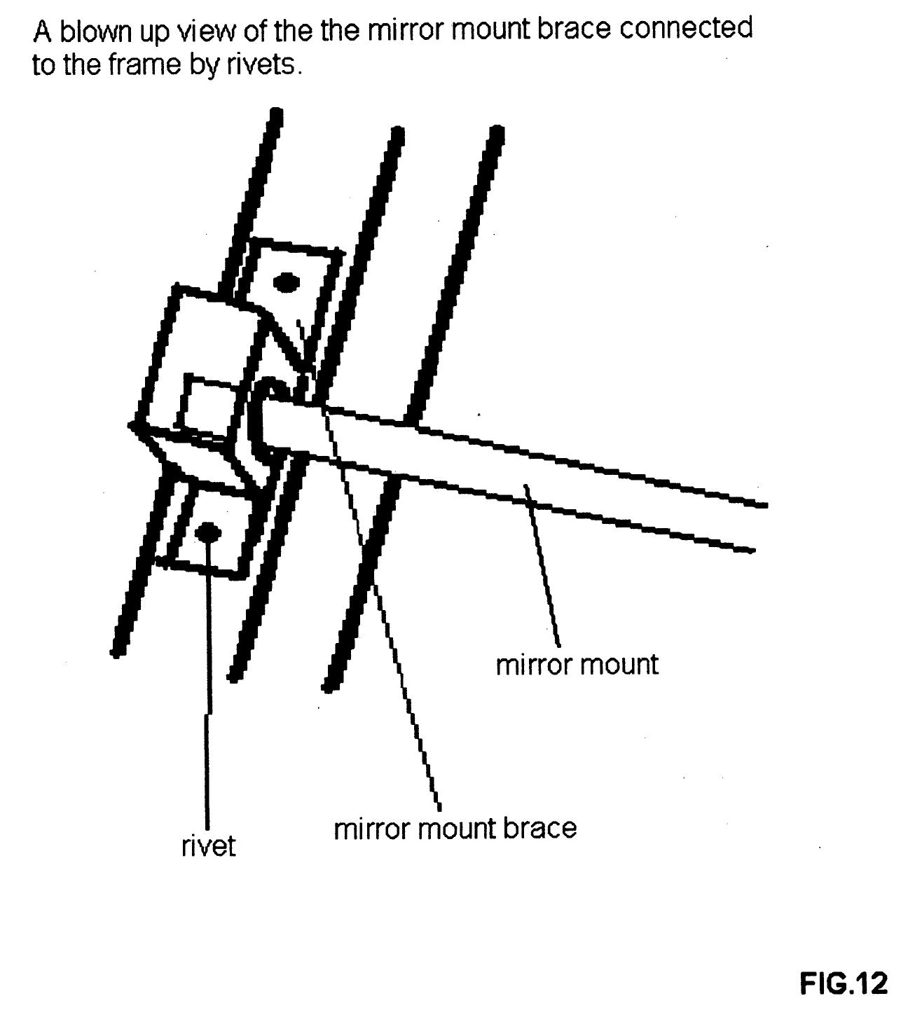

FIG. 11 is a perspective view of the frame from the back. It has two mirror mounts, attached by braces held in place with rivets. The mounts are made of ½-inch diameter aluminum rod. They are 17 inches long. The braces and rivets are aluminum. The attachment of the mirror mounts and braces is illustrated in FIG. 12.

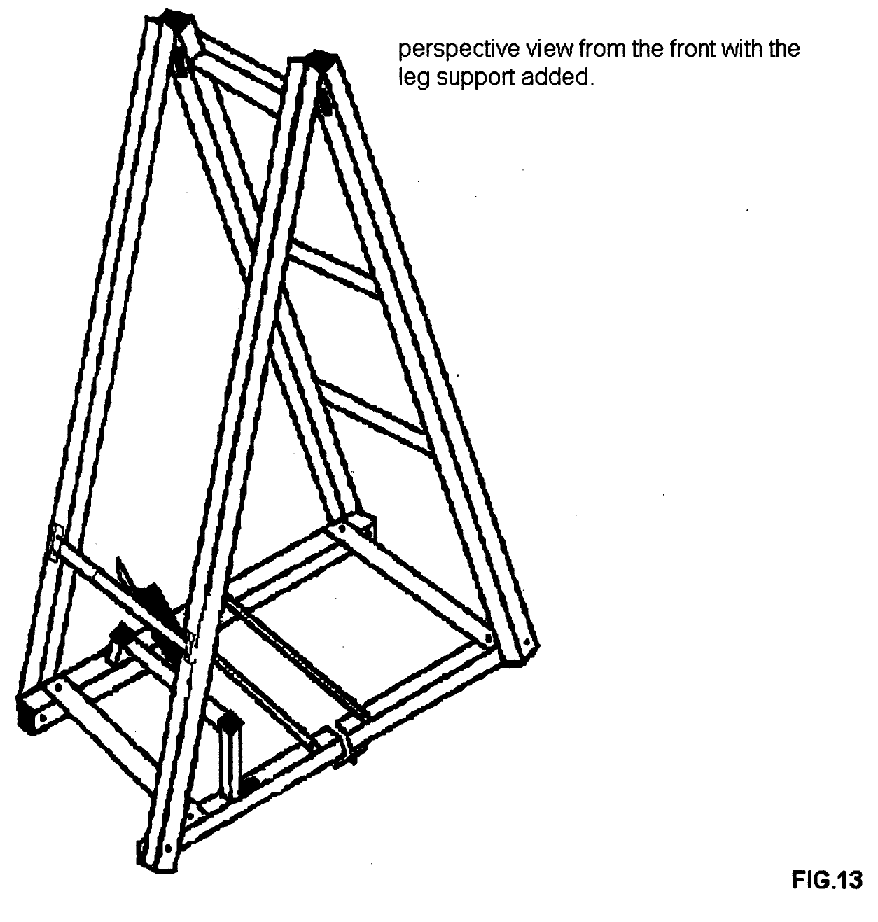

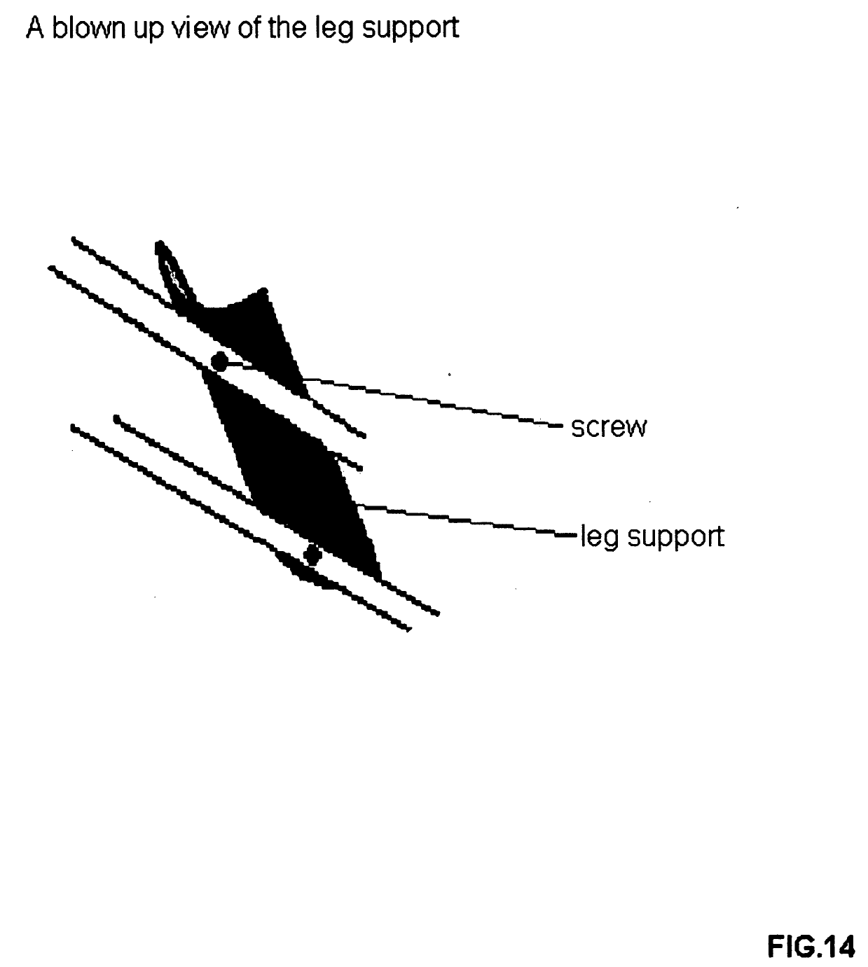

FIG. 13 is a perspective view from the front with the leg support in place. The leg support is made out of factory curved, high-density smooth plastic. The leg rest is a ¼-inch thick. The opening where one places their calf is 3 inches across and 6 inches long. The leg support is attached to a hinge system with two recessed screws, as shown in FIG. 14. The leg rest is painted high gloss white for ease of cleanliness. The hinge system automatically folds the leg support when the device is in the closed position. The hinge system consists of two aluminum rods. They have a ½ inch diameter and a 15 inch and 17 inch length. The rods are held in place by the illustrated bracket and support system as shown in FIGS. 13, 14, and 15.

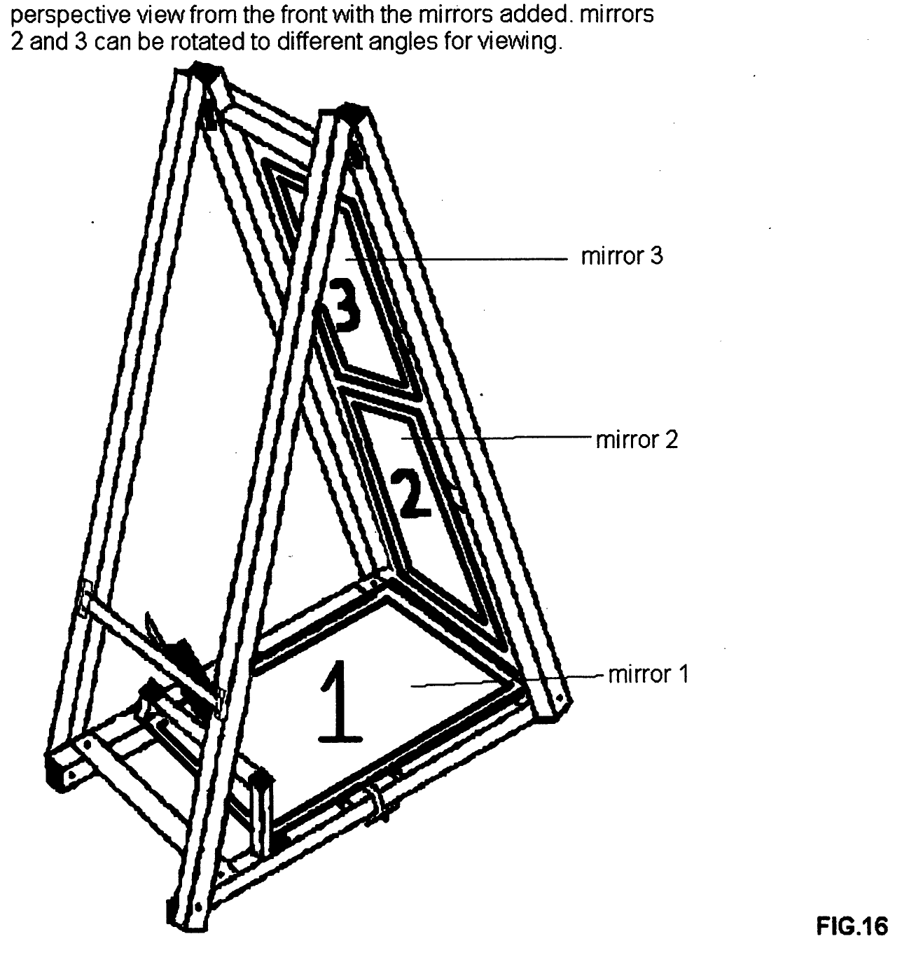

FIG. 16 is a perspective view from the front of the device. This view includes mirrors 2 and 3 that can be rotated to different angles for foot viewing. These mirrors are both 14½ inches long by 11½ inches wide. It also includes mirror 1 which is 22 inches long by 12½ inches wide. The reflective surface of mirrors 1, 2 and 3 is reduced by ½ inch on all four of their sides because of the aluminum framing.

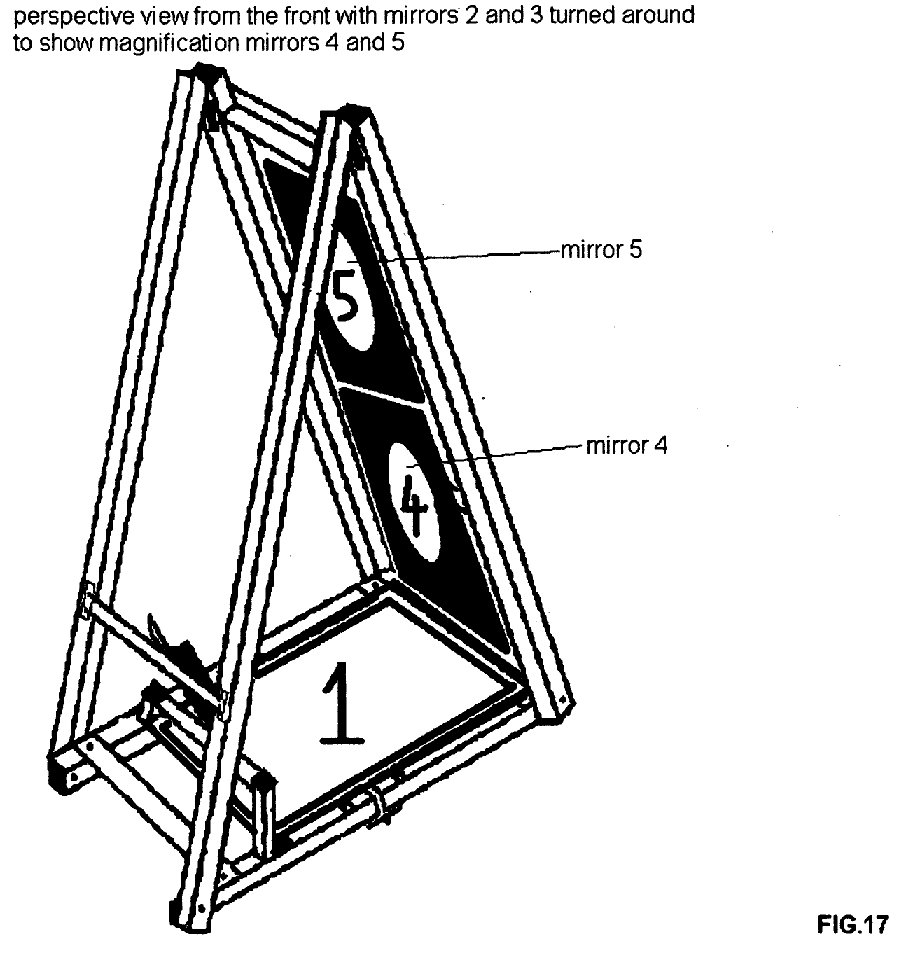

FIG. 17 is a perspective view from the front with mirrors 2 and 3 turned around to show magnification mirrors 4 and 5. Mirrors 4 and 5 each have a diameter of 9 inches and are attached with glue to the backs of mirrors 2 and 3 respectively. The reflective surface is reduced by a ½ inch around the circumferences because of glass framing.

FIGS. 16 and 17 are perspective views of the device in the open position. FIG. 16 draws attention to mirrors 2 and 3. FIG. 17 draws attention to mirrors 4 and 5, which are the magnification mirrors. They have a magnification power of 5 times normal vision. These magnification mirrors are normally used by people with weak vision or when someone may be trying to look at a very small foreign object, such as a splinter in their foot.

FIGS. 16 and 17 has mirror 1 as one of the components represented in it. The function of mirror 1 is of two fold. One function is, one may observe various parts of one's foot in mirror 1 directly. The second function is that it performs as a reflective base for mirrors 2 and 3.

FIGS. 16 and 17 is what the user of the device would observe when being seated in front of the device. For self-examination, one would sit in front of the device and remove any foot covering that they may be wearing. One would now place their calf on the leg rest. One may now observe bottom parts of their foot in mirror 1. One may now adjust mirrors 2 and 3, so that mirror 2 reflects the bottom and lower sides of their foot. This reflection originates from mirror 1. Mirror 3 reflects the ball of the foot, the toes, and all of the spaces between them. Mirrors 4 and 5 are now rotated into place for extreme close up examination of any very small problem areas.

Following self-examination of both feet, if anything out of the ordinary was observed one should seek the help of a health care professional.

FIGS. 16, 17, and 20 allows one to observe the simplicity of the invention. It requires only cleaning of the mirrors and the leg rest for complete functionality. This simplicity leads to lower manufacturing cost and therefore lower cost to the consumer.

FIGS. 16 and 17 allows one to observe how simple it is for the individual to give ones self a complete foot self-examination.

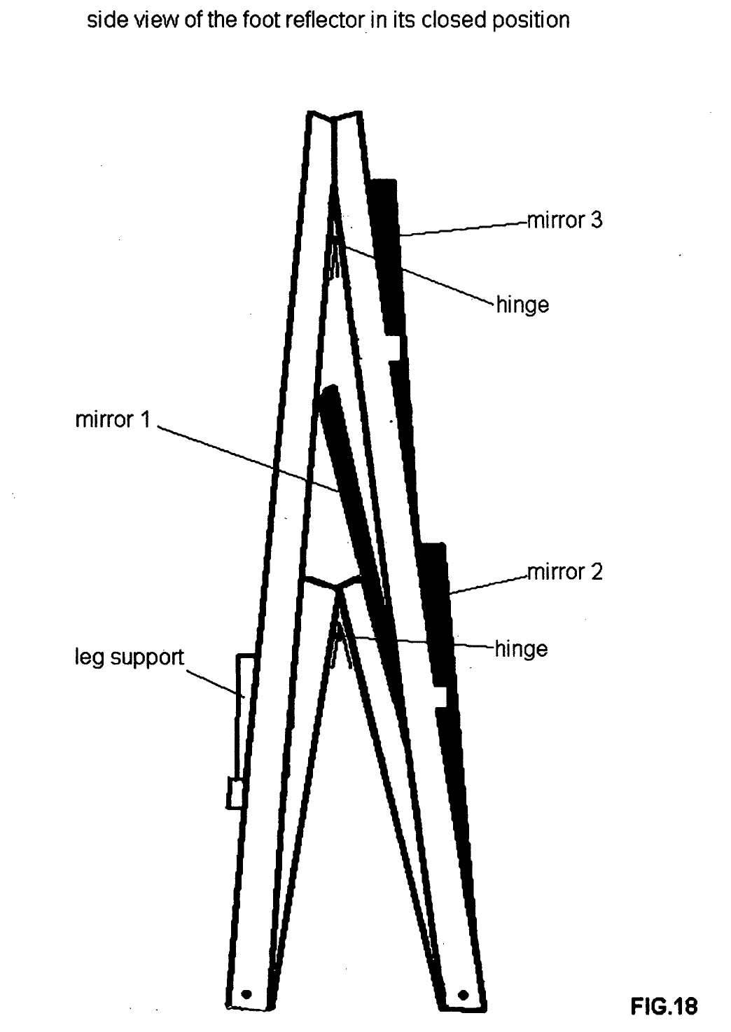

FIG. 18 allows one to observe how easy it is to close and transport the invention.

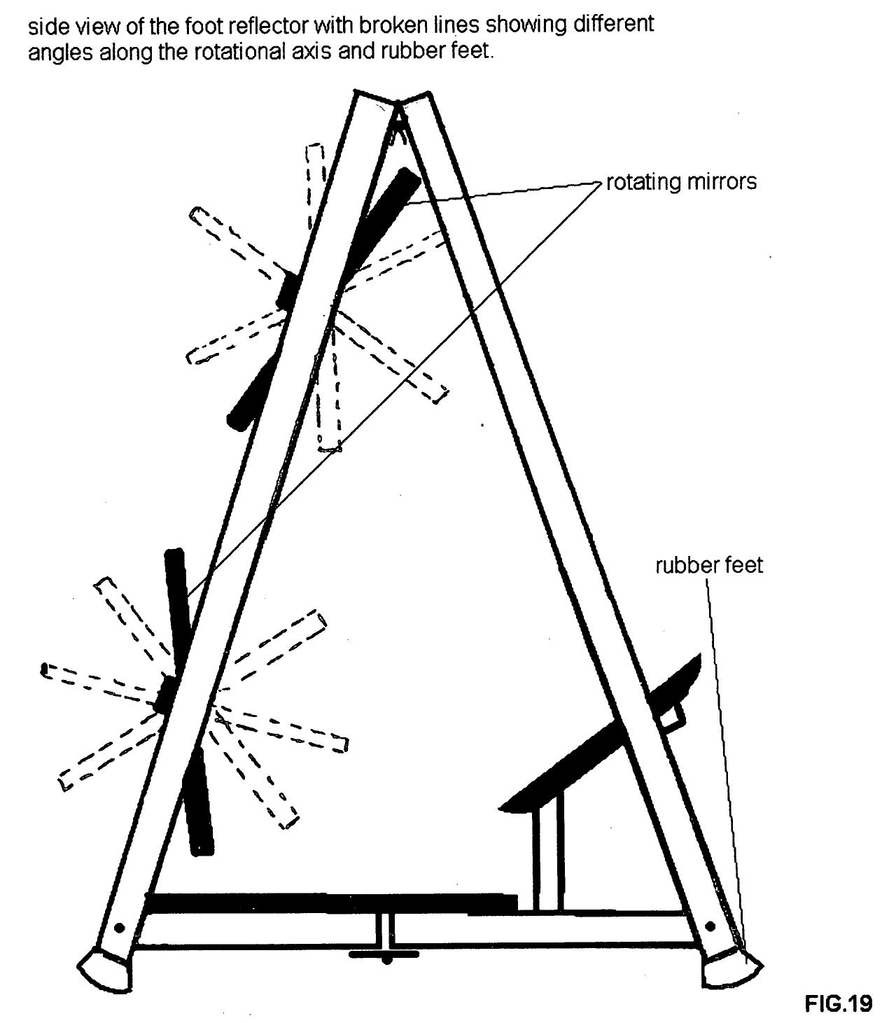

FIG. 19 is a side view of the Portable Foot Reflector with broken lines showing different angles that mirrors 2, 3, 4 and 5 can be positioned. It also shows the attached rubber feet at the bottom of the four angled frame structures. They are placed there to lend stability to the entire unit.

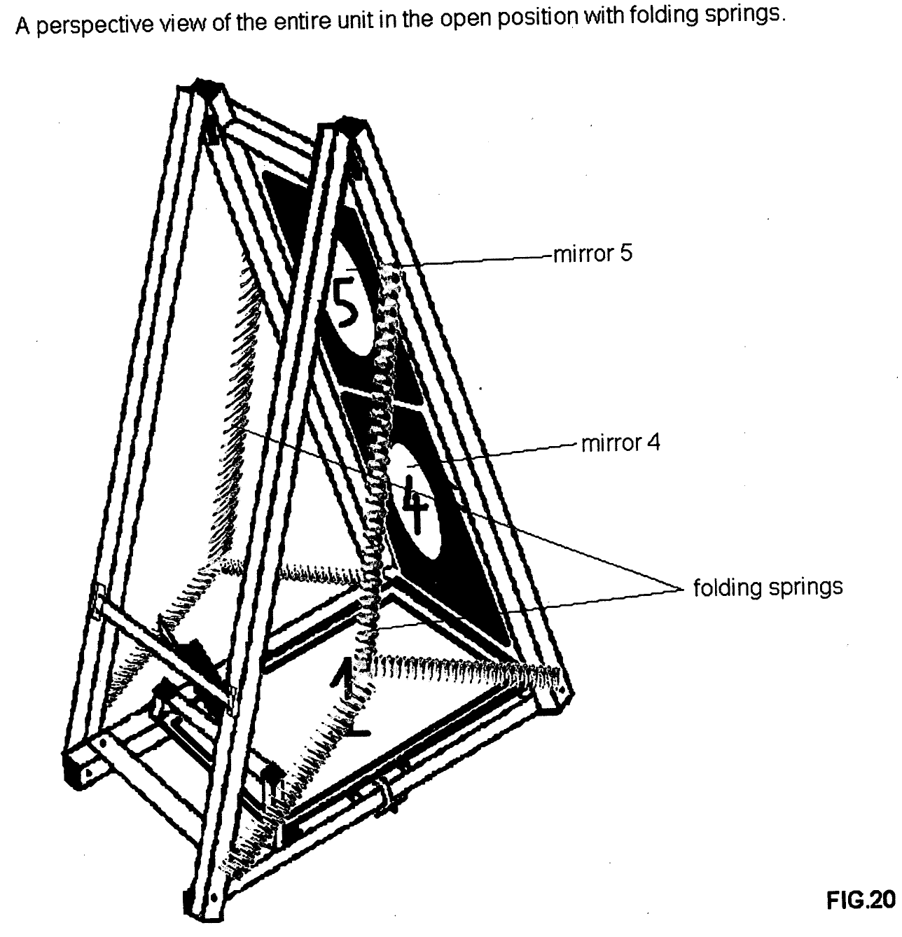

FIG. 20 is a perspective view of the entire unit. It is in the open position with the attached folding springs. The function of the folding springs is to make the closing of the invention very simple and easy. The springs also help create stability when the unit is in the open position. Closing is performed by grabbing the 16 inch top cross section frame structure in one hand and applying slight upward pressure with the other hand to the lower hinge

Taking into consideration the ease of maintenance, the relative low cost to the consumer, and the simplicity of use by its design coupled with the fact that all health care professionals who observed its use recommend it. That all testers of the device were pleased with their self-examinations make this invention a must in the homes of people with circulatory problems.

The following is a complete list of materials used in the manufacture of the invention. It is as follows 1) a pint container of high strength glue, 2) 1 mirror 22 inches by 12½ inches which includes the ½ inch thick frame, 3) 2 mirrors 14½ inches by 11½ inches including the ½ inch thick frame, 4) 2 magnification mirrors that magnify 5 times normal vision- the diameter of each is 9 inches including the ½ inch glass frame, 5) half of a white plastic drain pipe, 6 inches long, 3 inches across, and ¼ inch thick, 6) 4 light weight tension springs each measuring 16 inches in length and ½ inch diameter while in the relaxed position, 7) One length of flat aluminum with a thickness of ¼ inch, length of 60 inches and a width of a ½ inch, 8) 4 hinges which are 3 inches long and 1 inch wide and 2 hinges 1 inch by 1 inch, 9) one box of 100 count aluminum rivets with a ¼ inch head and a ½ inch length, 10) four nut and bolt sets each 3 inches long with ¼ inch nuts, 11) on aluminum rod ½ inch diameter and a 72 inch length, 12) 3 pieces of square aluminum tubing measuring 1 inch per side, 96 inches long, and with a wall thickness of ⅙ inch, 13) one box of 24 count metal nut an bolt sets, each ½ inch long with a ¼ inch, 14) four heavy duty rubber end caps with a ½ inch opening, 15) four pieces of 1 inch diameter and ½ inch thick pieces of plastic, 16) six small spring holders.

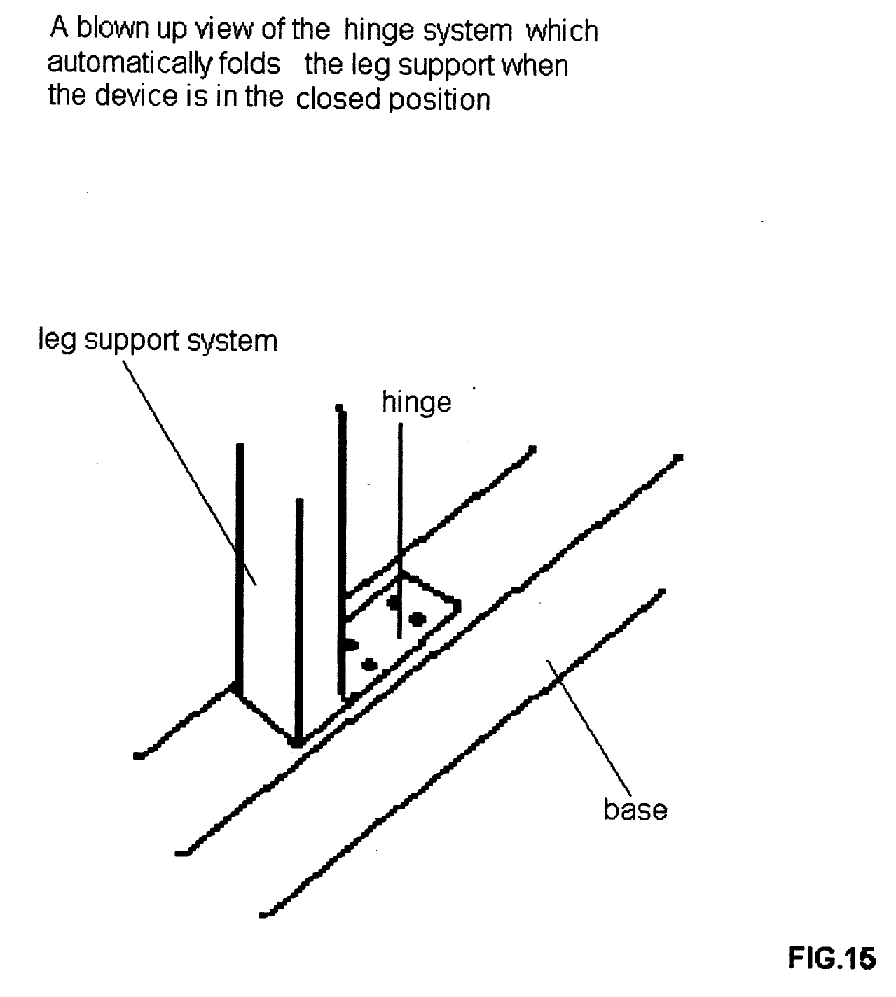

This is the procedure for making this invention. Assembly should be preformed in the following sequence.
1. Cut the 1 inch aluminum tubing into the following lengths: four pieces 37 inches, four pieces 12 inches, two pieces 9½ inches, two pieces 15 inches, one piece 18 inches, eight pieces 3 inches and two pieces 6 inches.
2. Cut the ½ inch diameter rod into the following lengths: three pieces 17½ inches and one piece 15 inches.
3. Cut the ½ inch wide flat metal into four lengths of 15 inches.
4. Connect two to the 37 inch long pieces using the 1-inch hinge and small nuts and bolts. Create an inverted V shape as in FIG. 1. Repeat the procedure a second time.
5. While referring to FIG. 3 connect two of the 12 inch pieces using a 3-inch long hinge. Repeat this procedure a second time.
6. While referring to FIG. 3 connect the hinged assemblies using the four pieces of 15 inch flat metal with rivets.
7. While referring to FIG. 7 and FIG. 8 attach the two inverted V shaped assemblies to the assembly from FIG. 3 with four of the 3 inch long bolts and nuts.
8. While referring to FIG. 9 trim the ends of the 18 inch piece of square tubing so that it can be used as the support beam. Attach it using rivets as shown in FIG. 10.
9. While referring to FIG. 12, carefully examine the mirror mount brace blow up. Take four pieces of the 3-inch long square tubing, cut them into braces, drill holes and attach them with rivets. The locations are centered at 12½ inches and 27½ inches up the inverted V shaped frame. Attach two braces to one side, insert the end of a 17½ inch long rod into each brace, insert the other ends of the rods into holes on the other two braces. Attach the other two braces to the frame.
10. The following is the procedure for attaching the leg support. One must refer to FIG. 13, FIG. 14, and FIG. 15 for clarity. Attach two of the 9½ inch long square tubing on the bottom framing. They are placed 5 inches from the end opposite the side that has the mirror mounts. Perform the attachment using the 1 inch square hinges with rivets. The hinge is riveted only on the side toward the center of the frame.
11. Drill a ½ inch diameter hole in each of the 9½ inch long tubes. Center the hole 1 inch from the top. The hole should run from the outside of the frame inwards. Insert the 15 inch round tube from one 9½ inch support to the other.
12. Attach the 15 inch flat metal 3 inches from the top of the two 9½ inch leg supports using rivets.
13. Attach a piece of 3 inch square tubing to each leg of the frame nearest the leg support. It should be centered 14 inches from the bottom of the rubber end cap. Please refer to FIG. 13, FIG. 14, and FIG. 15. Use rivets for the attachment process.
14. Drill a ½ inch diameter hole in each of the 3 inch pieces. The hole should be centered 1 inch from the end furthest from the frame. Insert the 17 inch long round rod from one support to the other.
15. While referring to the blow up in FIG. 13, center and attach the curved leg support using either rivets or screws.
16. While referring to FIG. 16, attach the mirror measuring 22 inches by 12½ inches using the high strength glue. This is labeled mirror 1.
17. While referring to FIG. 16, mirrors 2 and 3, which are 14½ inches by 11½ inches, should be centered and attached to their respective mounting rods. This is performed using the high strength glue. The mounting should be located in the middle of the mirrors on the non-reflective surface.
18. On the back of mirrors 2 and 3, located 1 inch about the mounting rod, attach with glue a 3 inch long piece of square tubing. This tube should be parallel to the mounting rod.
19. Repeat step 18 but use the 6 inch square rods and locate them 1 inch below the mounting rod.
20. On the non-reflective side of mirrors 2 and 3, attach a magnification mirror to each. Please use the following procedure for attachment.
21. Locate the magnification mirrors so that the mounting rod bisects the middle rear of them.
22. Center and glue one piece of solid plastic to each of the 3 inch and 6 inch square tubes that are on the backs of mirrors 2 and 3. Now attach the magnification mirrors to the plastic tubes using glue.
23. Look at FIG. 16 and FIG. 17 to make sure you have attached all mirrors correctly.
24. Please refer to FIG. 20 while attaching the folding springs. Four inches from the bottom of all of the four inverted V shaped frame pieces, attach a spring holder. This is done on the outside of the frame with a rivet. Five inches from the top of the framing structure, on the two tubes holding the mirror mounts, attach a spring holder. This is done on the outside of the frame using a rivet.
25. Attach one 16 inch spring to the holder on the bottom of the inverted V structure and stretch it and attach it to the other spring holder on the lower part of the frame on it's side.
26. Repeat step 25 on the other side of the frame.
27. Attach one 16 inch spring to the spring holder near the top of the frame structure. Stretch it and attach it to the middle of the stretched spring running along the lower part of the frame.
28. Repeat step 27 on the other side of the frame.
29. At the lower four ends of the framing stricture, attach the four rubber feet. Please refer to FIG. 19 in order to observe how they should be placed.
30. As observed in FIG. 19 make certain the mirrors rotate and hold their positions properly.
31. While referring to FIG. 18, make sure the invention opens and closes properly.

What is claimed is:

1. The Portable Foot Reflector is a unique combination of five mirrors with a leg support and a built in folding mechanism. This will allow a user of the device to self-examine the entire area of their foot for infections or foreign objects.

2. The Portable Foot Reflector according to claim 1, has two magnification mirrors which can be adjusted to whatever angle one may need for self-examination.

3. The Portable Foot Reflector according to claim 1, has two normal mirrors which can be adjusted to whatever angle one may need for self-examination.

4. The Portable Foot Reflector according to claim 1, has a stationary mirror which is used for direct observation of one's foot and as a reflective base for the other four mirrors.

5. The Portable Foot Reflector according to claim 1, has a unique leg support system which allows one to comfortably self-examine one's foot.

6. The Portable Foot Reflector according to claim 1, has a distinctive combination of springs and hinges which easily allows the device to fold closed for ease of storage and transportation.
